(19) United States
(12) Patent Application Publication
(10) Pub. No.: US 2026/0283892 A1
(43) Pub. Date: Sep. 24, 2026

(54) PAIN RELIEF HEAD DEVICE

(71) Applicant: Sebstara, LLC, Dallas, TX (US)

(72) Inventor: Mojan Safavi AMIRLAK, Dallas, TX (US)

(21) Appl. No.: 19/575,839

(22) Filed: Mar. 23, 2026

Related U.S. Application Data
(60) Provisional application No. 63/776,820, filed on Mar. 24, 2025.

(51) Int. Cl. A61H 7/00

(52) U.S. Cl. CPC A61H 7/006; A61H 7/001; A61H 2201/1607; A61H 2201/168; A61H 2205/021; A61H 2205/022; A61H 2205/04

(57) ABSTRACT

Certain aspects of the present disclosure provide a pain relief head device and a method for operating the pain relief head device. A pain relief head device includes a frame body. The pain relief head device includes a plurality of contact members coupled to the frame body. The plurality of contact members are configured to selectively apply external pressure to a plurality of locations on the patient’s head, neck, and/or face to occlude a plurality of blood vessels associated with the plurality of locations. The pain relief helmet similarly treats pain. The pain relief helmet includes a helmet with variable and adjustable contact members attached, and may include detachable pressure applicators.

### CROSS-REFERENCE TO RELATED APPLICATIONS

This application claims the benefit of U.S. Provisional Application No. 63/776,820, filed Mar 24, 2025, the entire contents of which are hereby incorporated by reference.

### BACKGROUND

### Field of the Disclosure

Aspects of the present disclosure relate to pain relief and, more particularly, to a pain relief head device.

### Description of Related Art

Headaches and migraines are among the most common neurological disorders, affecting millions of people globally. A headache is a general term for pain or discomfort in the head or neck region. As used herein, headache may refer to any of, but is not limited to, tension-type headaches, new daily persistent headaches, occipital neuralgia, and cluster headaches. Migraines are characterized by recurrent episodes of moderate to severe throbbing pain, often on one side of the head. Migraines are typically accompanied by symptoms such as nausea, vomiting, and heightened sensitivity to light, sound, and smells. Migraine episodes may also include visual or sensory disturbances, known as aura, preceding or accompanying the headache phase.

The pathophysiology of headaches and migraines is believed to involve complex interactions between the central and peripheral nervous systems, trigeminal nerve activation, and vascular changes. Recent studies by peripheral nerve surgeons performing surgery for treatment of migraines and headache disorders have identified peripheral nerve compression, sometimes also referred to as peripheral nerve entrapment or compression neuropathy, as a cause or instigator of headaches and migraines.

The human head and neck include many arteries, veins, and nerves, some of which are illustrated in FIG. 1. It is noted that FIG. 1 depicts certain aspects, but does not depict the entirety of the human anatomy of the head and neck—for example, FIG. 1 does not depict the zygomaticotemporal artery. Peripheral nerve compression can cause headaches and migraines due to irritation or inflammation of nerves in the head and neck.

As one example, compression and/or irritation of the occipital nerves can lead to occipital neuralgia as well as propagation and start of occipital migraines, which causes pain radiating from the back of the head to the front and in the temples. The occipital artery is a major blood vessel in the head that branches from the external (posterior) carotid artery and supplies oxygenated blood to parts of the scalp, neck, and deep structure of the head. Recent scientific presentations and publications point to the fact that the peripheral vessels (arteries and/or veins), in turn, can cause dynamic compression of the nerves resulting in propagation and start of migraines and headaches. It is also possible that these peripheral vessels contribute to pain on their own through other mechanisms.

As another example, compression of the supraorbital nerve (SON) and/or supratrochlear nerve (STN) can trigger frontal migraines. The supraorbital vessel and/or supratrochlear vessel are branches of the ophthalmic vessel. The supraorbital artery (SOA) exits the orbit through the supraorbital foramen accompanying the supraorbital nerve and join branches of the superficial temporal artery and other arteries in the scalp to supply blood to the upper eyelid, forehead, and anterior scalp. The supratrochlear artery (STA`) exits the orbit medially, above the trochlea accompanying the supratrochlear nerve, and ascends in the midline to supply blood to the central forehead. The SON and STN can get compressed or irritated by bony compression, muscle/fascia compression, or irritation as well as arteriolar or venous dynamic compression or irritation.

As yet another example, compression of the zygomaticotemporal nerve can cause pain around the eyes or temples. The zygomaticotemporal artery is a small arterial branch that contributes to the blood supply of the temporal region and areas around, and above, the zygomatic bone. The zygomaticotemporal artery at times accompanies the zygomaticotemporal nerve in the lateral wall of the orbit. The zygomaticotemporal artery enters the temporal fossa through the zygomaticotemporal foramen.

Compression of the nerves may occur due to tight muscle fascia, nearby blood vessels, scar tissue, bone, or physical trauma. Chronic irritation can lead to inflammation, sensitization, and activation of the trigeminovascular system, a key player in migraine pathophysiology. The socioeconomic burden of headaches and migraines is substantial, with impacts on productivity, quality of life, and healthcare resources.

Some treatments for peripheral nerve compression include physical therapy to reduce muscular tension and improve posture. Another treatment involves botulinum toxin (Botox) injections to relax muscles around the affected nerve. Another example treatment involves pharmacological interventions, such as the prescription of anti-inflammatory medications (e.g., triptans, calcitonin gene-related peptide (CGRP) inhibitors) or nerve-modulating drugs (e.g., gabapentin).

For chronic cases unresponsive to conservative therapy, nerve decompression surgery may be performed to relieve the pressure. Plastic surgeons specializing in peripheral nerve surgery have designed surgical maneuvers to eliminate compression on the nerves or to remove smaller nerves. In some cases, the surgical maneuver involves removal or ligation of blood vessels to relieve pressure on the nerves. The ligation and removal of the blood vessels, even without other surgical maneuvers, has positive results on eliminating or decreasing migraines and headaches. Although this is thought to be related to dynamic compression on the nerves, there could be other mechanisms involved. Thus, some techniques for pain elimination address decreasing the flow in the blood vessel alone—and do not necessarily involve any nerves.

Surgical treatment of migraines in the form of nerve decompression/avulsion/trigger point surgery has been on the rise. The term “migraine surgery” is used for surgical nerve decompression, nerve removal, or any other maneuvers such as ligation and removal of the vessels for not only treatment of migraines but other headaches disorders mentioned above. The term “migraine surgery” has been evolved and used interchangeably with terms such as nerve decompression surgery or trigger deactivation surgery. Certain clinicians prefer to use the term “migraine surgery” for any surgery that addresses the above pathologies, while others may use other terms such as trigger deactivation or migraine and headache surgery.

The popularity of these surgery treatments stems from its high rate of success, and the issues and side effects that migraine medications cause. However, surgical ligation or removal of blood vessels is invasive. When the blood vessels are ligated or cauterized proximally for the purpose of decreasing pain, the hope is that the blood flow does not recur. However certain larger blood vessels, such as the occipital artery (OA) and superficial temporal artery, may have a backflow after proximal ligation. In this case, proximal occlusion of the vessel may not fully eliminate the dynamic pressure of the vessel on the nerve. These vessels may need a double occlusion mechanism both proximally and distally. Surgically, in the case of the OA and STA, the proximal and distal area of the artery in relation to the dynamic compression point on the nerve is ligated or cauterized. Another surgical technique is the total removal of the offending area of the vessel in the case of OA.

Accordingly, there is a need for innovative solutions that address the underlying vascular mechanisms and provide effective, non-invasive treatments for headache and migraine sufferers. Such solutions may replicate the therapeutic effects of surgical vessel ligation or occlusion without requiring invasive procedures, while allowing for selective targeting of specific blood vessels based on the patient’s symptoms and anatomy.

### SUMMARY

One aspect provides a pain relief head device. The pain relief head device includes a frame body configured to be mounted to a patient’s head and a plurality of contact members coupled to the frame body. Each contact member comprises at least one pressure applicator. The plurality of contact members are configured to selectively apply external pressure to a plurality of locations on the patient’s head, neck, and/or face to occlude a plurality of blood vessels associated with the plurality of locations.

Another aspect provides a method for treating a headache or migraine with the pain relief head device. The method includes mounting a pain relief head device to a patient’s head, the pain relief head device comprising a frame body and a plurality of contact members coupled to the frame body. The method further includes identifying one or more symptoms of the patient, determining a plurality of blood vessels of the patient’s head, neck, and/or face to occlude based at least on the one or more identified symptoms, and adjusting the plurality of contact members to apply external pressure to a plurality of locations on the patient’s head, neck, and/or face to occlude the plurality of determined blood vessels.

Another aspect provides a pain relief helmet. The pain relief helmet includes a body configured to be worn on a patient’s head and a plurality of pressure applicators disposed on an inner surface of the body. The plurality of pressure applicators are configured to apply external pressure to a plurality of locations on the patient’s head, neck, and/or face to occlude a plurality of blood vessels associated with the plurality of locations.

Another aspect provides a method for treating a headache or migraine with the pain relief helmet.

The pain relief head device and pain relief helmet are configured to create pressure points on a wearer’s face, head, and neck.

The following description and the appended figures set forth certain features for purposes of illustration.

### BRIEF DESCRIPTION OF DRAWINGS

The appended figures depict certain features of the various aspects described herein and are not to be considered limiting the scope of this disclosure.

FIG. 1 is a diagram of blood vessels in the human head according to certain aspects.

FIG. 2A is a diagram of an anterior view of an example pain relief head device mounted to a human patient’s head according to certain aspects.

FIG. 2B is a diagram of an anterior view of the example pain relief head device depicting pressure locations applied to respective blood vessels and topographic anatomy in the patient’s head according to certain aspects.

FIG. 3 is a diagram of a left oblique superior anterior view of the example pain relief head device mounted to the patient’s head according to certain aspects.

FIG. 4A is a diagram of a left lateral view of the example pain relief head device mounted to the patient’s head according to certain aspects.

FIG. 4B is a diagram of the left lateral view of the example pain relief head device depicting pressure locations applied to respective blood vessels in the patient’s head according to certain aspects.

FIG. 5 is a diagram of a left oblique superior posterior view of the example pain relief head device mounted to the patient’s head according to certain aspects.

FIG. 6A is a diagram of a posterior view of the example pain relief head device mounted to the patient’s head and neck according to certain aspects.

FIG. 6B is a diagram of the posterior view of the example pain relief head device depicting pressure locations applied to respective blood vessels in the patient’s head according to certain aspects.

FIG. 7A is a diagram of a superior view of the example pain relief head device mounted to the patient’s head according to certain aspects.

FIG. 7B is a diagram of the superior view of the example pain relief head device depicting pressure locations applied to respective blood vessels in the patient’s head according to certain aspects.

FIG. 8A is a diagram of a first view of an example pain relief helmet according to certain aspects.

FIG. 8B is a diagram of a second view of the example pain relief helmet according to certain aspects.

FIG. 9 illustrates example pressure applicators according to certain aspects.

FIG. 10 illustrates an example method for treating a headache or migraine according to certain aspects.

### DETAILED DESCRIPTION

Aspects of the present disclosure provide a pain relief head device and a method of treating pain using the pain relief head device and a pain relief helmet. It should be understood, that while aspects of the disclosure are described with respect to treating headaches, migraines, new daily persistent headaches, occipital neuralgia, and, in some aspects, the pain relief device may be used to treat other types of pain using external pressure selectively applied using the pain relief head device.

In some aspects, the pain relief device is configured to apply external pressure to one or more specific blood vessels of a patient or user to decrease or eliminate migraines, chronic daily headaches, occipital neuralgia, and/or new daily persistent headaches by occluding the targeted blood vessels. As discussed in detail herein, in some examples, the pain relief device is configured to apply external pressure to both the proximal and distal occipital artery, temporal artery and proximal supraorbital, supratrochlear artery and zygomaticotemporal artery as well as the ability to put pressure and occlude the lumen of these blood vessels in their respective path. In some respects, the pain relief device is configured to apply external pressure, additionally or alternatively, to one or more other areas of the patient’s or user’s head, neck, and/or face to treat pain.

According to certain aspects, the pain relief head device is configured to selectively apply external pressure for occlusion of blood vessels in a patient’s head and neck.

According to certain aspects, the pain relief head device is configured to selectively apply external focal pressure on any area of the head, neck, or face.

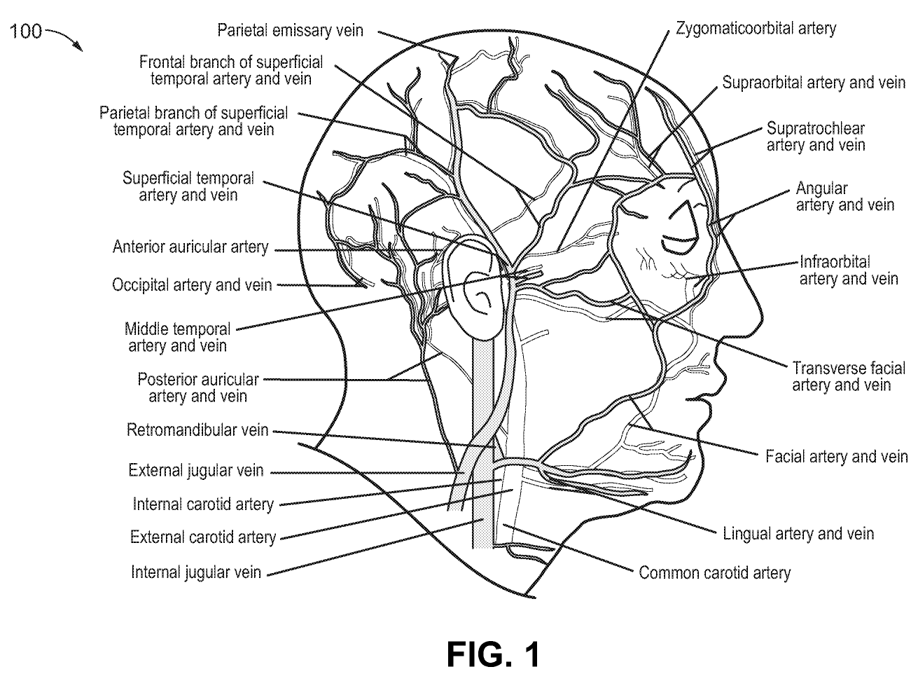

According to certain aspects, the pain relief head device is configured to selectively apply external pressure to one or more blood vessels on a patient’s head, neck, and/or face. In some aspects, the pain relief head device is configured to selectively apply the external pressure to a plurality of pressure points for vascular dynamic compression. FIG. 1 is a diagram of blood vessels in the human head 100 according to certain aspects.

According to certain aspects, the pain relief head device and pain relief helmet are configured to, additionally or alternatively, selectively apply external pressure on one or more other trigger points on areas of the patient’s head or neck, that do not involve compression of blood vessels, in order to treat headaches and migraines. In some aspects, the pain relief head device is configured to selectively apply the external pressure on the one or more other trigger relief points which could be random in location with variable diameters of the areas of applied pressure. For example, other trigger points may include areas that the fascia or muscle are irritating the nerve or boney compression of the nerve is the offender. Trigger relief points could be related to any of these areas or any area that the patient feels pain relief. The areas may be tender areas or non-tender areas. These “trigger relief” areas can provide pain relief due various reasons, such as myofascial relaxation which in turn lessens the pressure on the nerves, distraction by applying pressure on areas other than the tender or painful areas, psychological influence of the use of pressure device, and/or even placebo effect.

According to certain aspects, the pain relief head device is configured to selectively apply external pressure to the one or more blood vessels based on one or more symptoms identified by the patient (e.g., tender, aching, or throbbing areas, or other based on other symptoms and/or combination of symptoms), Doppler signals, patient preference, medical provider preference, and/or based on the patient’s anatomy and physiology (e.g., the patient’s topographic neurovascular Doppler anatomy).

In some aspects, the pain relief head device is configurable to selectively apply external pressure to selected locations on the patient’s head, face, and/or neck. In some aspects, the pain relief head device is configurable to selectively apply a variable amount of external pressure to the selected locations on the patient’s head, face, and/or neck.

In some aspects, each external pressure may be applied to an area from around 0.1 mm to around 100 mm in diameter on the patient’s head, neck, and/or face with a number of pressure points ranging from 1 to 100.

In some aspects, the external pressure applied by the pressure applicators may be sufficient to at least partially occlude blood flow through the targeted blood vessel. In some aspects, the pressure applied may range from about 5 mmHg to about 200 mmHg, depending on the blood vessel being targeted and the patient’s anatomy. In some aspects, the pressure may be applied continuously for a treatment duration ranging from about 1 minute to about 60 minutes, or longer as needed. In some aspects, the pressure may be applied intermittently, with periods of pressure application alternating with periods of pressure release.

The idea of the external compression and occlusion of the vessels to decrease or eliminate flow aims to decrease or eliminate the flow in the blood vessels at trigger sites without invasive incisions with an external compression device. In this way, the pain relief head device may replicate the therapeutic effects of surgical vessel ligation or occlusion without requiring invasive procedures.

While a design of the pain relief devices may be based on a topographic and clinically-assessed location of blood vessels, other external compression mechanisms could contribute to decreasing pain that do not involve the blood vessels. Such pressure points that do not involve vascular occlusion could involve the muscle and fascia causing relaxation of the pressure on the nerves, muscle and fascia without relaxation of the pressure on the nerve, or even pressure on the nerve itself resulting in paradoxical decrease in pain. Therefore, the pain relief devices herein may focus on occluding the vessels mentioned herein, however, the pain relief devices described herein allow selection of the contact points to apply external focal pressure to other areas that are not defined by anatomy of vessels or nerve. If the patients feels any decrease of pain in such areas, these can be used as routine treatment points rather than the predefined vascular compression points.

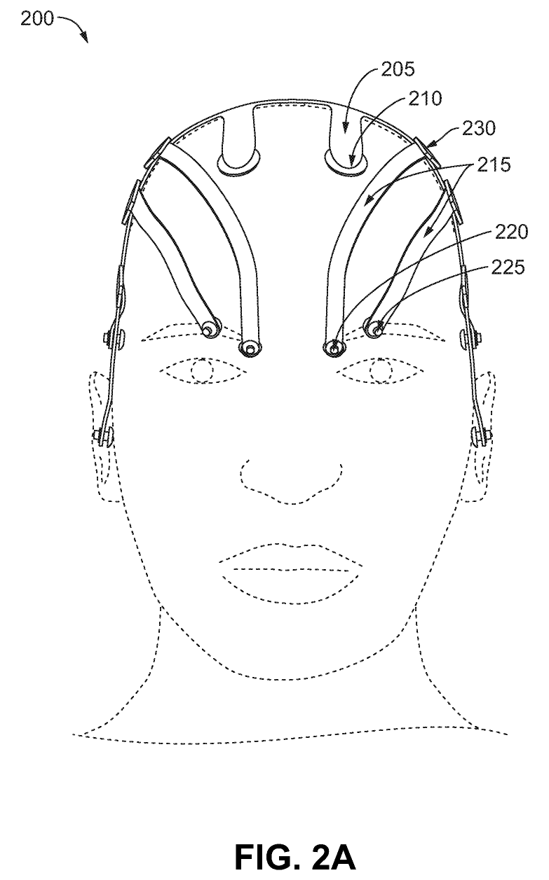

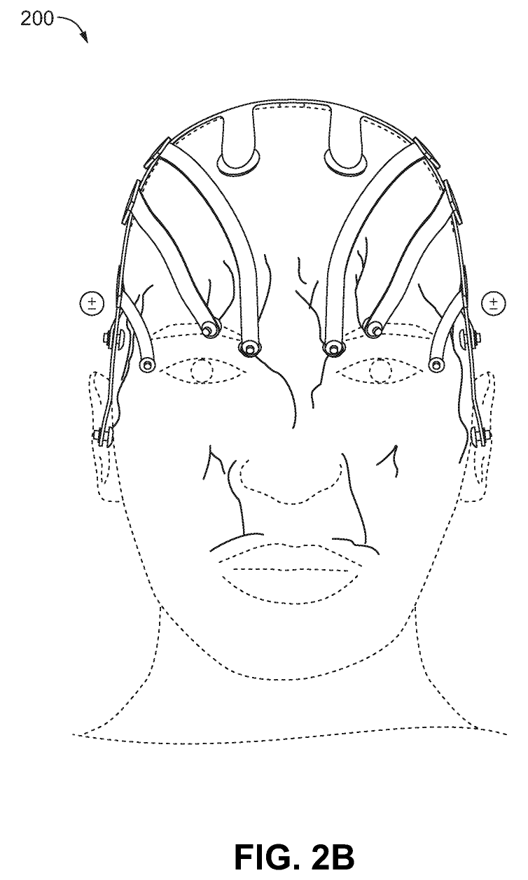

FIGS. 2A-7B illustrates an example pain relief head device 200 mounted to a patient’s head. While FIGS. 2A-7B illustrate a particular configuration of an example pain relief head device 200 configured to selectively apply pressure to certain example blood vessels, it should be understood that different configurations of the pain relief head device may be used and may be configured to selectively apply pressure to different, or additional, blood vessels and/or to other trigger points on the patient’s head and/or neck that provides relief.

In FIGS. 2A-7B, the components depicted by a knob represent adjustable components coupled to the device body and the adjustable contact members. Nerves typically accompany and/or intersect arteries, however, the nerves are not depicted in FIGS. 2A-7B.

According to certain aspects, the pain relief head device is configured to be mounted to a patient’s head. In some aspects, the device body of pain relief head device is shaped to fix a human head, or may be configurable to fit the patient’s specific anatomy. In some aspects, the device body is malleable to fit the patient’s head as the pain relief head device is mounted to the patient’s head as shown in FIGS. 2A, 3, 4A, 5, 6A, and 7A. In some aspects, the frame body includes a number of anchors. In some aspects, the anchors help hold the frame body in a desired position. In some aspects, the anchors may include a foam pad or other suitable material to provide comfort to the patient.

FIG. 2A is a diagram of an anterior view of an example pain relief head device 200 mounted to a human patient’s head according to certain aspects. FIG. 2B is a diagram of an anterior view of the example pain relief head device 200 depicting pressure locations applied to respective blood vessels in the patient’s head according to certain aspects.

As shown in FIGS. 2A-2B, the device frame 205 includes multiple contact members 215 that extend from the device frame 205 to various areas of the patient’s head, neck, and/or face. In some aspects, the frame body 205 may be rigid or malleable. In some aspects, the frame body 205 conforms to the shape of the wearer’s head. In some aspects, the material of the frame body 205 resting on the wearer’s scalp for stability of the pain relief head device 200 is selected to be comfortable on the wearer’s head with flexible or semi-rigid material that has a partial memory or malleability and/or semi-rigid material. In some aspects, the pain relief head device 200 may include head straps with elastic material to control the amount of pressure.

As shown in FIGS. 2A-2B, the device frame 205 includes anchors 210. Anchor points can be variable in location and size. In some aspects, the anchors 210 may include a foam pad; a soft silicone pad; closed-cell or open-cell foam; leather; or rigid plastic covered in foam, leather padding, or cloth padding; or other suitable material to provide comfort to the patient at the point of contact. For example, the anchors 210 may be formed of elastic cloth, rubber, leather, or other material. In some aspects, the anchor points are wide, helping to conformably support the frame body 205 on the wearer’s head.

In some aspects, the contact members 215 extend from the frame body 205. In some aspects, the contact members 215 have the pressure applicators at a bottom surface (the patient side) of the contact member. In addition the entire patient surface of the contact members 215 may also act as independent strips of “pressure areas” and not just the pressure points at the pressure applicators. The pressure applicators and/or the entire bottom surface of the contact members 215 may be closed-cell or open-cell foam padding or similar material for comfortable application and even pressure applied.

In some aspects, the contact members 215 are made of a semi-flexible material such that the contact members 215 can be bent into a desired position and to apply a desired amount of pressure. In some aspects, the contacts members 215 are made of a malleable wires (e.g., a malleable aluminum alloy), a metal reinforced wire, and/or may be covered in a hard or soft silicon. In some aspects, the contact members 215 can be moved in to position to apply the external pressure by the patient or medical provider using their finger(s).

In some aspects, the contact members 215 are coupled to the frame body 205 with a coupling member 230. In some aspects, the coupling members may be tightened or loosened to allow the contact members 215 to have excursion and vector direction. In some aspects, the contact members 215 may be integrated with the frame body 205. In some aspects, the coupling member 230 may be an adjustable knob or joint. In some aspects, the contact members 215 may be moved to a wider selected position using the adjustable knob, and then bent to apply pressure to a precise area. In some aspects, the adjustable knob may be configured to adjust the amount of pressure applied. As shown, each contact members 215 may include one or more pressure applicators 220, 225. In some aspects, the contact members 215 serve as pressure surfaces themselves. In some aspects, the contact members 215 occlude a run off path of one or more blood vessels. As shown in the example depicted in FIG. 2A, the example pain relief head device 200 may be configured with the contact members 215 to apply external pressure to the proximal supratrochlear (STA`) vessel with the pressure applicator 220 and to the proximal supraorbital (SOA) vessel with the applicator 225. Generally, the selection and locations to apply the pressure applicators may be based on a topographical pattern of the blood vessels and/or nerves, based on tender areas experienced by the patient or user, based on patient or physician preference on areas that may relieve the pain, and/or based on arteriolar and/or venous Doppler patterns.

In some aspects, the coupling member 230 may comprise a ball joint, a pivot joint, a ratchet mechanism, a friction fit mechanism, or a combination thereof. In some aspects, the coupling member 230 may include a locking mechanism configured to lock the contact member 215 in a desired position. In some aspects, the coupling member 230 may include a quick-release mechanism configured to allow rapid repositioning or removal of the contact member 215.

In the example depicted in FIG. 2B, the contact members may be configured to apply external pressure to the supraorbital artery (1), the supratrochlear artery (2), the proximal superficial temporal artery (3), and the distal superficial temporal artery (4).

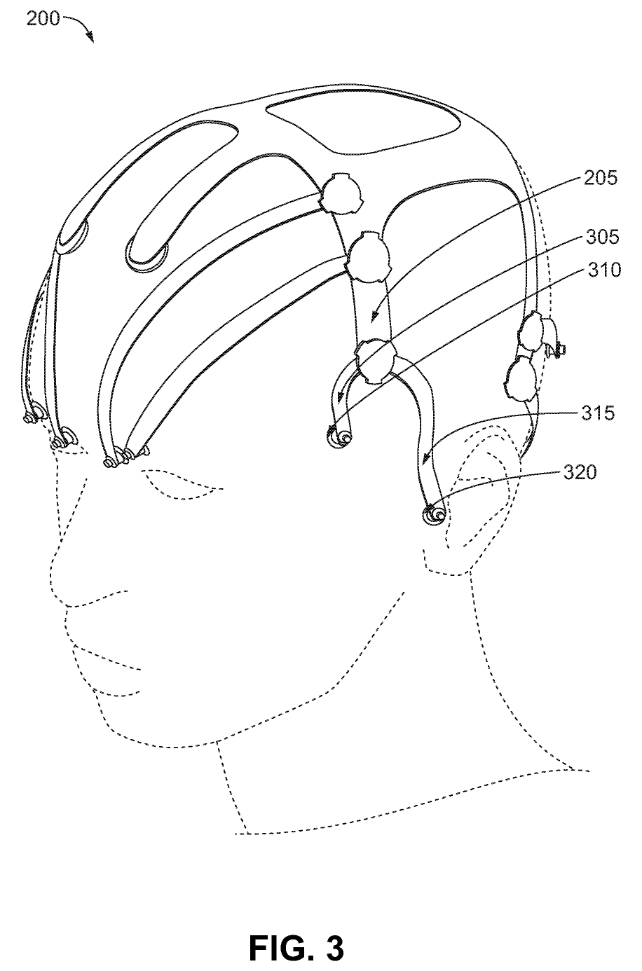

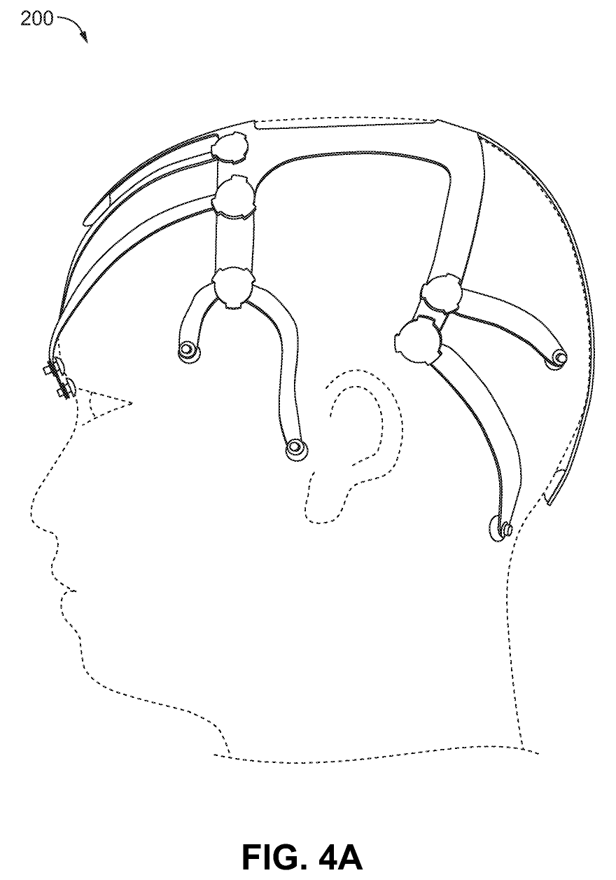

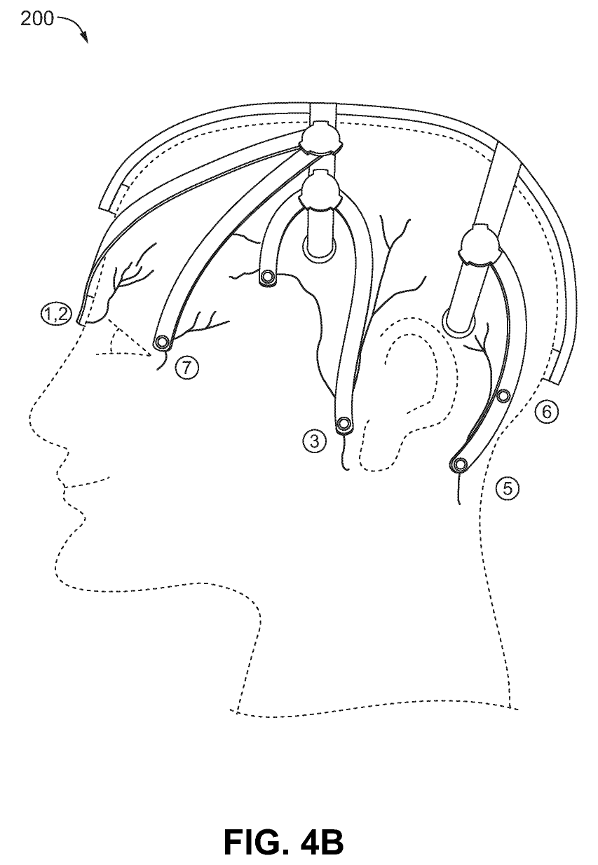

FIG. 3 is a diagram of a left oblique superior anterior view of the example pain relief head device 200 mounted to the patient’s head according to certain aspects. As shown in FIG. 3, the pain relief head device 200 may include the contact members 305 and 315 extending from the frame body 205. The contact member 305 may be configured to occlude the distal superficial temporal (STA) with the pressure applicator 310. For example, the pressure applicator 310 may occlude back flow from the anterior branch of the STA (e.g., frontal branch) or posterior branch of the STA (e.g., parietal branch). The contact member 315 may be configured to occlude the proximal STA with the pressure applicator 320. Additional pressure applicators similar to pressure applicator 310 can be used to occlude the proximal flow of zygomaticotemporal artery (shown in FIG. 2B and FIG. 4B).

FIG. 4A is a diagram of a left lateral view of the example pain relief head device 200 mounted to the patient’s head according to certain aspects. FIG. 4B is a diagram of the left lateral view of the example pain relief head device 200 depicting pressure locations applied to respective blood vessels in the patient’s head according to certain aspects. As shown in FIG. 4B, the contact members may be further configured to apply external pressure to the proximal occipital artery (5), the distal occipital artery (6), and the zygomatico temporal artery (7). It should be understood that while FIGS. 3-4B depict anchor points of the frame body and contact members of the pain relief head device on the left side of the patient’s head, the pain relief head device equally includes the anchor points and contact members on the right side of the patient’s head.

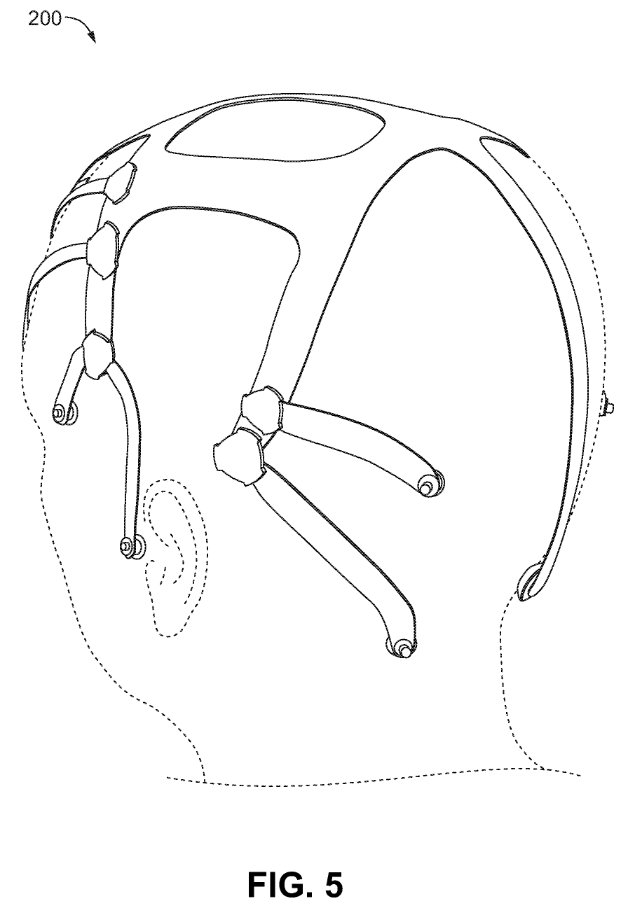

FIG. 5 is a diagram of a left oblique superior posterior view of the example pain relief head device 200 mounted to the patient’s head according to certain aspects.

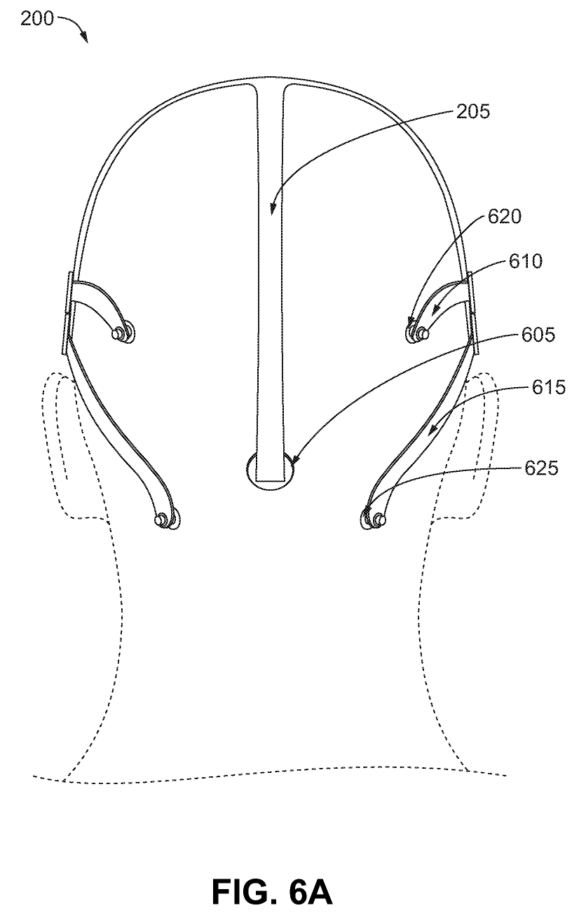

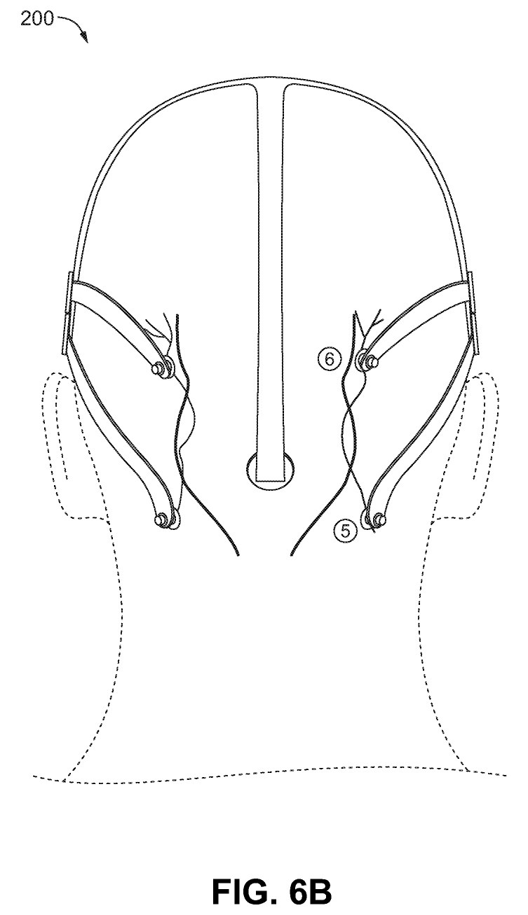

FIG. 6A is a diagram of a posterior view of the example pain relief head device 200 mounted to the patient’s head according to certain aspects. As shown in FIG. 6A, the frame body 205 may include an anchor 605. As shown, the pain relief head device 200 may include the contact members 610 and 615 extending from the frame body 205. The contact member 610 may be configured to occlude the distal occipital (OA) with the pressure applicator 620. For example, the pressure applicator 620 may occlude backflow from the OA branches. The contact member 615 may be configured to occlude the proximal OA with the pressure applicator 625.

FIG. 6B is a diagram of the posterior view of the example pain relief head device 200 depicting pressure locations applied to respective blood vessels in the patient’s head according to certain aspects.

As shown in FIG. 6B, the contact members may be further configured to apply external pressure to the proximal occipital artery (5) and the distal occipital artery (6) on both the left and right sides of the back of the patient’s head.

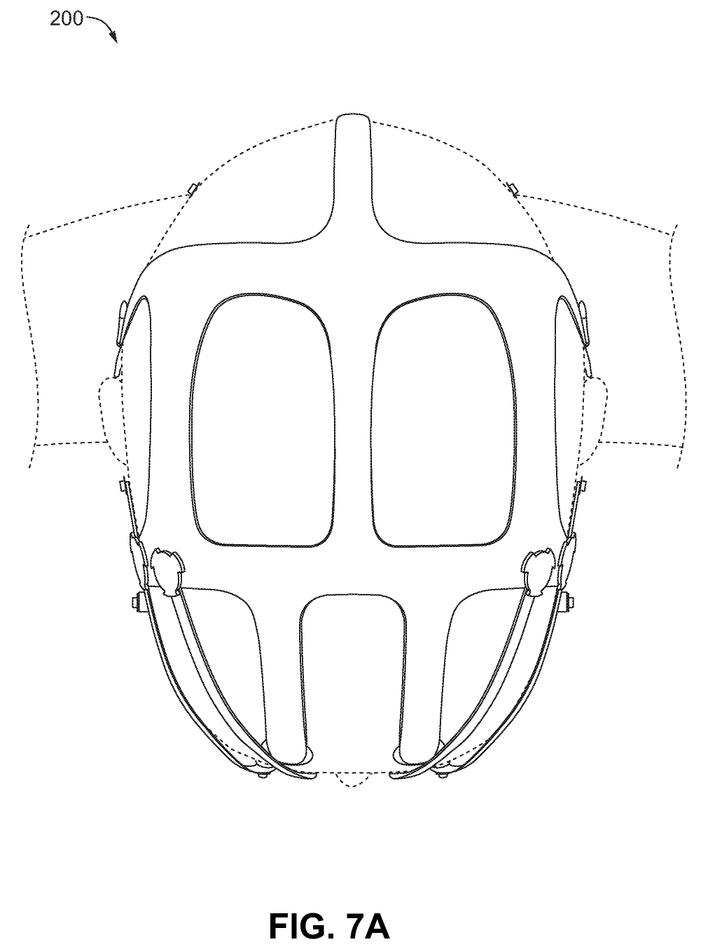

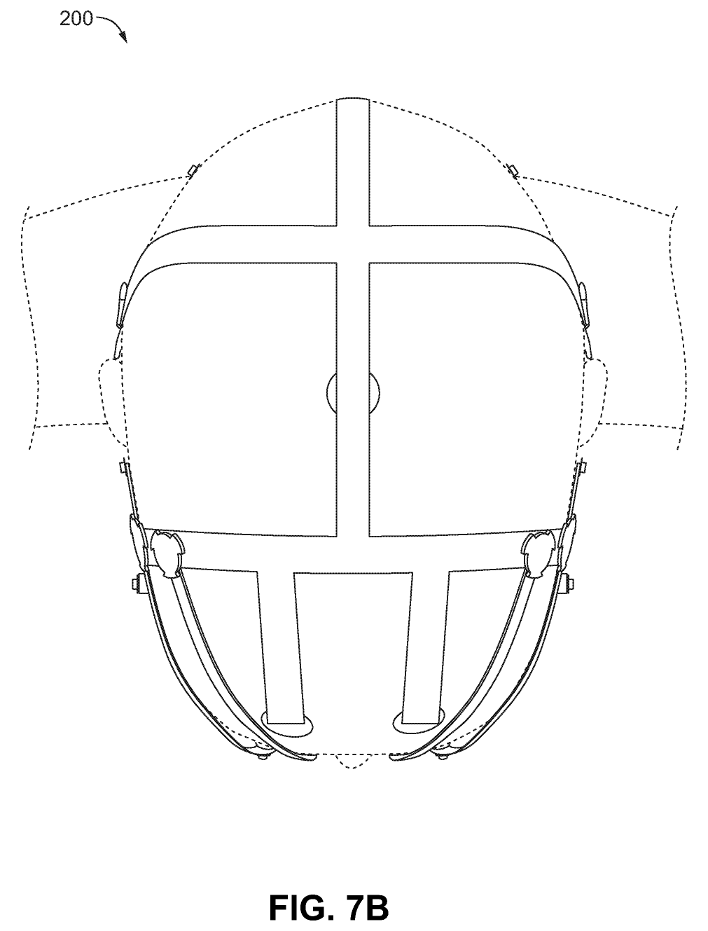

FIG. 7A is a diagram of a superior view of the example pain relief head device 200 mounted to the patient’s head according to certain aspects. FIG. 7B is a diagram of the superior view of the example pain relief head device 200 depicting pressure locations applied to respective blood vessels in the patient’s head according to certain aspects.

As shown in FIGS. 2A-7B, the pain relief head device is configured to selectively apply external pressure both proximally and distally on certain arteries, such as the occipital artery. As discussed above, while FIGS. 2A-7B depict the pain relief head device configured to selectively apply pressure to the supraorbital artery, the supratrochlear artery, the proximal superficial temporal artery, the distal superficial temporal artery, the proximal occipital artery, the distal occipital artery, and the zygomatico temporal artery, that the pain relief head device may be configured to apply focal pressure to additional or different blood vessels and/or to additional or different trigger points, or trigger reliefs, on the patient’s head, neck, and/or face not associated with blood vessels.

In some aspects, the pain relief head device may be coupled to an external stabilizing device (e.g., a tripod, a wall, or a chair mount) to offload or reduce pressure on the anchor points of the pain relief head device (e.g., pressure added by the weight of the device).

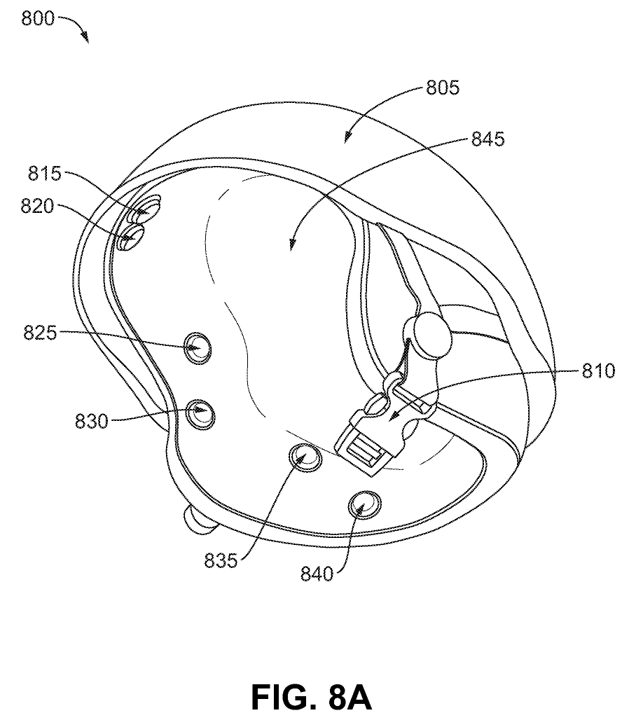

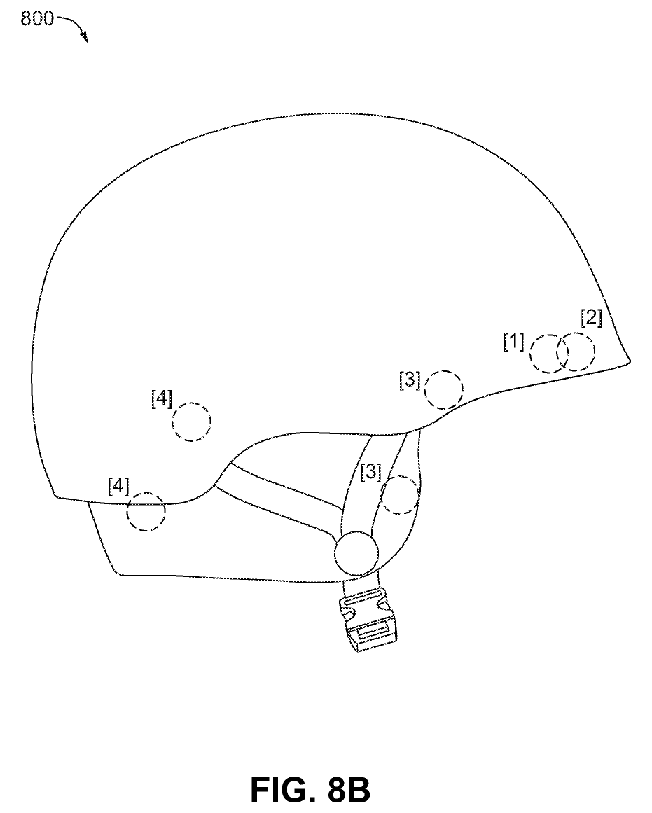

According to certain aspects, the pain relief head device may be a pain relief helmet. FIGS. 8A-8B illustrates an example pain relief helmet 800. While FIGS. 8A-8B illustrate a particular configuration of an example pain relief helmet 800 configured to apply pressure to certain example blood vessels, it should be understood that different configurations of the pain relief helmet may be used and may be configured to selectively apply pressure to different, or additional, blood vessels and/or to other trigger and pain relief points on the patient’s head and/or neck.

As shown in FIG. 8A, the pain relief helmet 800 includes a body 805. The body 805 may comprise the helmet shell. In some aspects, the body 805 is a hard shell conforming generally the shape of a human head. In some aspects, the body 805 is soft or malleable shell conforming to the shape of the patient’s or user’s head.

In some aspects, the pain relief helmet 800 may include an attachment mechanism configured to secure the pain relief helmet 800 on the wearer’s head. As shown, the pain relief helmet 800 include a strap 810 with a clip configured to attach to another strap and clasp under the wearer’s chin. In some aspects, the strap 810 can be tightened (e.g., in multiple vectors) in order to adjust the amount of pressure applied by the pressure applicators 815, 820, 825, 830, 835, 840. In some aspects, the pressure may be applied by way of a helmet stand. For example, a pain relief helmet may be coupled with a stand (e.g., similar to a stand up hair dryer) configured to apply the pain relief helmet to a user with a variable amount of counter force.

In some aspects, the attachment mechanism may comprise one or more of: an adjustable elastic band, a ratcheting adjustment mechanism, a magnetic closure, a hook-and-loop fastener, or a combination thereof. In some aspects, the pain relief helmet 800 may include padding on an interior surface of the body 805 to provide comfort and help distribute pressure evenly across the patient’s head.

The pain relief helmet includes multiple pressure applicators on an inner surface 845 of the body 805. As shown, the pain relief helmet 800 includes the pressure applicators 815, 820, 825, 830, 835, and 840. The pressure applicator 815 may be configured to apply external pressure to the supratrochlear. The pressure applicator 820 may be configured to apply external pressure to the supraorbital. The pressure applicators 825 and 830 may be configured to apply external pressure to the temporal. The pressure applicators 835 and 840 may be configured to apply external pressure to the occipital. It should be understood that while FIG. 8A illustrates the pressure applicators on the right side of the pain relief helmet 800, the pain relief helmet 800 may additionally include the pressure applicators on the opposite left side of the pain relief helmet.

In some aspects, the pressure applicators may be made of closed-cell or open-cell foam or silicone material, or any other similar material that can apply fixed or variable degrees of pressure.

In some aspects, the pressure applicators may comprise a gel material, a memory foam material, an inflatable bladder, or a spring-loaded mechanism. In some aspects, the pressure applicators may have a durometer hardness ranging from about 10 Shore A to about 90 Shore A, depending on the desired pressure characteristics. In some aspects, the pressure applicators may be interchangeable, allowing the patient or clinician to select pressure applicators of different sizes, shapes, or hardness levels based on the treatment needs.

In some aspects, the pressure applicators 815, 820, 825, 830, 835, and 840 can be repositioned. For example, the pressure applicators 815, 820, 825, 830, 835, and 840 may be repositioned based on patient preference, a predefined topographic anatomy (vascular or other) or by clinician-aided positioning. In some aspects, the pressure applicators 815, 820, 825, 830, 835, and 840 can be attached to the body 805 by way a detachable (e.g., Velcro) or non-detachable coupling.

In some aspects, the pressure applicators can be selectively applied. In some aspects, the pressure applicators may be selectively applied by selectively attaching the pressure applicators to the frame 805. For example, the pressure applicators may be attached or removed to and from the frame 805 by way of an attachment mechanism, such a Velcro. In some aspects, the outer surface of the body 805 may include one or more selectable mechanisms, such as a button or knob, that the user can manipulate (e.g., turn or press) in order to selectively apply pressure with an associated one of the pressure applicators.

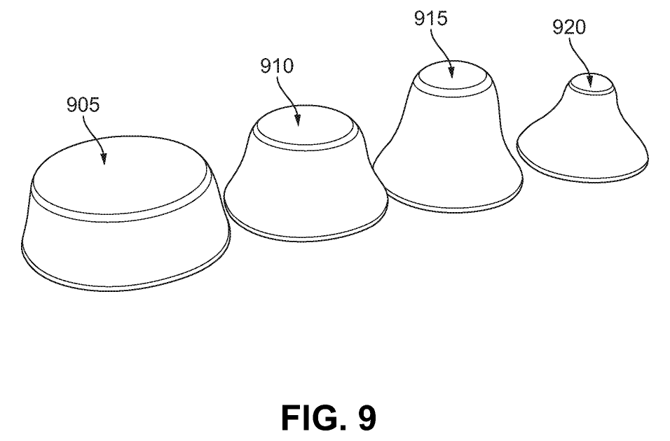

FIG. 9 illustrates example pressure applicators that may be used in a pain relief head device, such as any of the pain relief head devices illustrates in FIGS. 2A-8B. As shown, the pressure applicators 905, 910, 915, and 920 may vary in size, diameter, shape, height, and amount of pressure they can apply. In some aspects, the pressure applicators may be selectively used for the pain relief head device. In some aspects, the amount of pressure applied by a pressure applicator is variable based on the shape, texture and height of the pressure applicator. In some aspects, an applicator spring system may be configured to control the amount of external pressure applied by the pressure applicator.

While FIGS. 2A-9 illustrate examples of the pain relief devices having a number of pressure applicators, it should be understood that the pain relief devices may be configured to apply external pressure to various numbers of pressure point areas. The total number of pressure areas could be from 1 to 200. In addition, larger areas of pressure can be applied than illustrated in the examples herein (e.g., pressure to an area wider or longer than 100 mm) and in various shapes of pressure such as circular, rectangle, square and more. In some aspects, the contact members described herein can serve as pressure surfaces themselves to occlude the vessels and vessels in their path. This type of pressure on the path of the vessel rather than proximal and distal would be useful especially when the distal back flow of the vessel cannot be occluded, such as in the forehead in case of the SOA and STA’, the template and occipital vessels, or if there is further need of occlusion of accessory vessels or vessels that cannot be controlled with proximal and distal pressure alone.

According to certain aspects, a mapping may be generated that maps symptoms or other parameters to contact points (e.g., blood vessel pressure points or other trigger points). The contact members of pain relief head device may be configured to be selectively applied based on the mapping. In some aspects, the mapping of the contact points includes the location of the contact point, an amount of pressure to be applied at the contact point, and/or a size (e.g., diameter) of the contact point.

In some aspects, the contact points may be selected randomly or based on the patient’s or user’s personal preference. For example, the patient or user may determine the contact points based on trial and error, in which the user selectively applies combinations of the contacts points to determine which combination(s) effectively treat the user’s pain symptoms.

In some aspects, the contact points may be selected based on topographic anatomy of the proximal vessels. In some aspects, a topographic heat map is mirrored inside the pain relief helmet 800 (e.g., within a range of 0.5 cm - 5 cm standard deviation).

In some aspects, the contact points may be selected based on topographic anatomy of the muscle, nerves, and proximal and distal vessels. In some aspects, the anatomy may be known anatomy, based on an in-office device measurement, or based on in office or at-home Doppler device measurement.

In some aspects for patients with occipital pain, the pain relief device is used to apply external pressure to occlude the proximal and distal occipital artery. The corresponding topographic mapping on the head is based on occlusion of the proximal occipital artery, which is variable but typically, located 3-6 cm below the occipital protuberance and 2-4 cm lateral to it. For temple pain, one of the areas that the pain relief device is used to apply external pressure to occlude the proximal common or anterior branch of the superficial temporal artery located approximately above, anterior or over of the temporomandibular joint (TMJ) and or tragus, and slightly at or behind the side burn hair line. The pain relief device may be used to apply external pressure to additional areas with or without applying external pressure to the primary areas described above, such as to the parietal branch of the superficial temporal artery or areas above the ear, in or behind the superior side burn hair line. In some aspects, the pain relief device may be used to apply external pressure to occlude the distal STA at around 7 cm -12 cm from the midline and at the hair lines or at around 0 cm - 4 cm from the anterior or posterior to the hair line. Another area of temple pain in some aspects, the pain relief device is used to apply external pressure to occlude the zygomaticotemporal artery at around 1.2 cm - 2 cm lateral and around 5 mm -10 mm superior to the lateral canthus. The exact location of the above topographic measurements can vary between head sizes and specific patient anatomy. For the forehead pain, in some aspects, the pain relief device can be used to apply external pressure to occlude the SOA and STA’ proximally at the rim midlimbus and inward and distally with only the contact members of the pain relief head device and/or via a broad internal pressure applicator of the pain relief helmet that covers a large area of the forehead. In some aspects, the mapping may be depicted on the inside of the pain relief helmet (e.g., drawn or printed on the inner surface of body 805). In some aspects, the mapping may be provided for the pain relief head device in a digital or printed guide.

According to certain aspects, multiple of the contact members of the pain relief head device or helmet are selected to occlude multiple blood vessels of the patient’s head, neck, and/or face to disrupt the flow through the artery, which may decrease dynamic pulsation on the irritated nerve. Because locating the blood vessels can be difficult, in particular, for a patient without medical knowledge, the proposed pain relief is advantageous because, the contact members of the pain relief head device are positioned on the pain relief head device such that, when the pain relief head device is mounted on the patient’s head, the contact members can be easily applied to occlude the blood vessels of interest or any other areas of interest (not for blood vessel occlusion, such as based on patient preference).

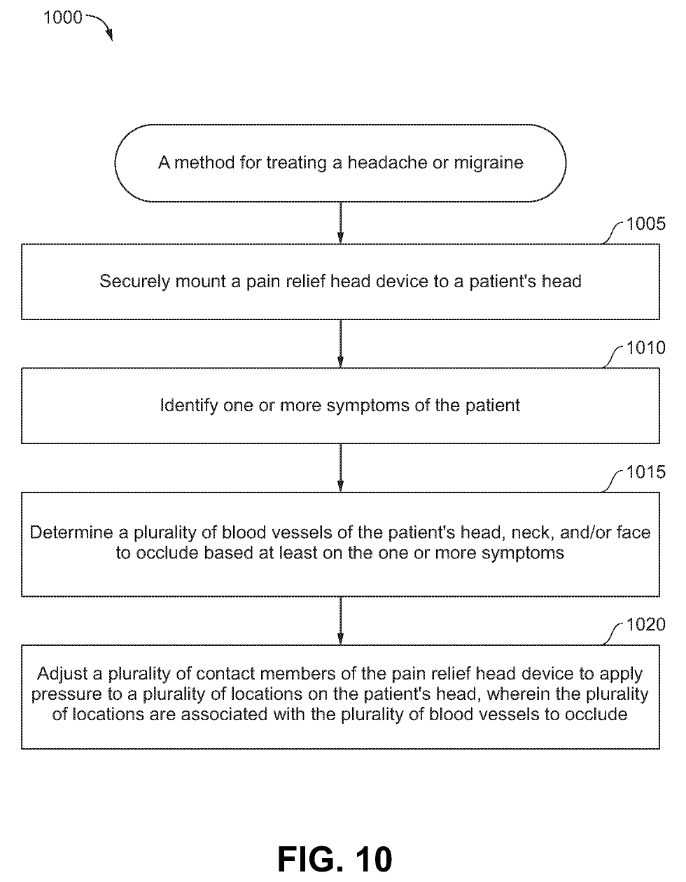

FIG. 10 illustrates an example method 1000 for treating a headache or migraine. Aspects of method 1000 may be performed by using a pain relief device such as, for example, the pain relief head device 200 and/or the pain relief helmet 800 discussed in more detail herein with respect to Figured 1-9. In some aspects, the pain relief head device may be operated by the patient. In some aspects, the pain relief head device may be operated by a medical provider for the patient. In some aspects, the pain relief head device may be operated automatically, and/or both automatically and with input from the patient or medical provider (e.g., a human provider, a virtual provider, an artificial intelligence (AI) provider), or non-medical representative or expert, or a virtual guide.

In some aspects, method 1000 may begin, at operation 1005, with securely mounting a pain relief head device to a patient’s head.

Method 1000 may include, at operation 1010, identifying one or more symptoms of the patient. In some aspects, method 1000 may further include determining one or more preferences of the patient and/or of a medical provider. In some aspects, method 1000 may further include determining one or more physiological parameters of the patient.

Method 1000 may include, at operation 1015, determining a plurality of blood vessels of the patient’s head, neck, and/or face to occlude based at least on the one or more identified symptoms of the patient. In some aspects, the determining may be further based on the identified preferences and/or physiological parameters. In some aspects, method 1000 may further include determining one or more other trigger points, not associated with a blood vessel, to apply external pressure based on the identified symptoms, preferences, and/or physiological parameters.

Method 1000 may include, at operation 1020, adjusting a plurality of contact members of the pain relief head device to apply external pressure to a plurality of locations on the patient’s head, neck, and/or face to occlude the plurality of determined blood vessels.

Use of the pain relief head device described herein may eliminate or decrease the occurrence and/or severity of headaches, migraines, chronic daily headaches, new daily persistent headaches, occipital neuralgia, and other pain relief.

In some aspects, the pain relief head device or pain relief helmet may be used as a standalone treatment or in combination with other treatments, such as pharmacological interventions, physical therapy, or relaxation techniques. In some aspects, the pain relief head device or pain relief helmet may be used prophylactically to prevent the onset of a headache or migraine, or may be used during an active headache or migraine episode to provide relief. In some aspects, the pain relief head device or pain relief helmet may be provided as part of a kit that includes multiple pressure applicators of varying sizes and shapes, a carrying case, and instructions for use.

### Example Aspects

Implementation examples are described in the following numbered clauses:

Clause 1: A pain relief head device in accordance with the aspects described herein.

Clause 2: A method for operating a pain relief head device to treat headaches or migraines in accordance with the aspects described herein.

Clause 3: An apparatus, comprising: a memory comprising executable instructions; and one or more processors configured to execute the executable instructions and cause the apparatus to perform a method for operating a pain relief head device to treat headaches or migraines in accordance with the aspects described herein.

Clause 4: A non-transitory computer-readable medium comprising executable instructions that, when executed by one or more processors of an apparatus, cause the apparatus to perform a method for operating a pain relief head device to treat headaches or migraines in accordance with the aspects described herein.

Clause 5: A pain relief helmet in accordance with the aspects described herein.

Clause 6: A method for operating a pain relief helmet to treat headaches or migraines in accordance with the aspects described herein.

Clause 7: An apparatus, comprising: a memory comprising executable instructions; and one or more processors configured to execute the executable instructions and cause the apparatus to perform a method for operating a pain relief helmet to treat headaches or migraines in accordance with the aspects described herein.

Clause 8: A non-transitory computer-readable medium comprising executable instructions that, when executed by one or more processors of an apparatus, cause the apparatus to perform a method for operating a pain relief helmet to treat headaches or migraines in accordance with the aspects described herein.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of aspects discussed without departing from the scope of the disclosure. Various examples may omit, substitute, or add various procedures or aspects as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A pain relief head device comprising:
a frame body configured to be mounted to a patient’s head; and
a plurality of contact members coupled to the frame body, each contact member comprising at least one pressure applicator;
wherein the plurality of contact members are configured to selectively apply external pressure to a plurality of locations on the patient’s head, neck, and/or face to occlude a plurality of blood vessels associated with the plurality of locations.

2. The pain relief head device of claim 1, wherein the plurality of blood vessels comprises one or more of: an occipital artery, a superficial temporal artery, a supraorbital artery, a supratrochlear artery, or a zygomaticotemporal artery.

3. The pain relief head device of claim 1, wherein the plurality of contact members are configured to apply external pressure both proximally and distally on at least one of the plurality of blood vessels to prevent backflow through the at least one blood vessel.

4. The pain relief head device of claim 3, wherein the at least one blood vessel comprises an occipital artery, and wherein a first contact member is configured to occlude a proximal portion of the occipital artery and a second contact member is configured to occlude a distal portion of the occipital artery.

5. The pain relief head device of claim 3, wherein the at least one blood vessel comprises a superficial temporal artery, and wherein a first contact member is configured to occlude a proximal portion of the superficial temporal artery and a second contact member is configured to occlude a distal portion of the superficial temporal artery.

6. The pain relief head device of claim 1, wherein the plurality of contact members are adjustable to selectively apply external pressure to selected locations on the patient’s head, neck, and/or face.

7. The pain relief head device of claim 1, wherein each contact member is coupled to the frame body with a coupling member, and wherein the coupling member is configured to adjust a position and/or pressure applied by the contact member.

8. The pain relief head device of claim 1, wherein the at least one pressure applicator is variable in at least one of: size, shape, or amount of pressure applied.

9. The pain relief head device of claim 1, wherein the frame body comprises a plurality of anchors configured to hold the frame body in a desired position on the patient’s head.

10. The pain relief head device of claim 9, wherein the plurality of anchors comprise a foam pad, a soft silicone pad, or a leather pad.

11. The pain relief head device of claim 1, wherein the contact members comprise a malleable material configured to be bent into a desired position.

12. The pain relief head device of claim 1, wherein the plurality of locations are selected based on one or more of: one or more symptoms identified by the patient, Doppler signals, topographic anatomy of the patient, or patient preference.

13. A method for treating a headache or migraine, the method comprising:
mounting a pain relief head device to a patient’s head, the pain relief head device comprising a frame body and a plurality of contact members coupled to the frame body;
identifying one or more symptoms of the patient;
determining a plurality of blood vessels of the patient’s head, neck, and/or face to occlude based at least on the one or more identified symptoms; and
adjusting the plurality of contact members to apply external pressure to a plurality of locations on the patient’s head, neck, and/or face to occlude the plurality of determined blood vessels.

14. The method of claim 13, wherein the plurality of blood vessels comprises one or more of: an occipital artery, a superficial temporal artery, a supraorbital artery, a supratrochlear artery, or a zygomaticotemporal artery.

15. The method of claim 13, wherein adjusting the plurality of contact members comprises applying external pressure both proximally and distally on at least one of the plurality of blood vessels to prevent backflow through the at least one blood vessel.

16. The method of claim 13, wherein determining the plurality of blood vessels is further based on one or more of: Doppler signals, topographic anatomy of the patient, or patient preference.

17. A pain relief helmet comprising:
a body configured to be worn on a patient’s head; and
a plurality of pressure applicators disposed on an inner surface of the body;
wherein the plurality of pressure applicators are configured to apply external pressure to a plurality of locations on the patient’s head, neck, and/or face to occlude a plurality of blood vessels associated with the plurality of locations.

18. The pain relief helmet of claim 17, wherein the plurality of blood vessels comprises one or more of: an occipital artery, a superficial temporal artery, a supraorbital artery, a supratrochlear artery, or a zygomaticotemporal artery.

19. The pain relief helmet of claim 17, wherein the plurality of pressure applicators are configured to apply external pressure both proximally and distally on at least one of the plurality of blood vessels to prevent backflow through the at least one blood vessel.

20. The pain relief helmet of claim 17, wherein the plurality of pressure applicators are repositionable based on one or more of: patient preference, a predefined topographic anatomy, Doppler signals, or clinician-aided positioning.
